(19) United States
(12) Patent Application Publication
(10) Pub. No.: US 2024/0383610 A1
(43) Pub. Date: Nov. 21, 2024

(54) PROPULSION SYSTEM FOR A NON-ROTARY-WING AIRCRAFT, AND ASSOCIATED AIRCRAFT

(71) Applicant: SAFRAN, PARIS (FR)

(72) Inventors: Christophe Ludovic Jean-Claude VIGUIER, MOISSY CRAMAYEL (FR); Yann FEFERMANN, MOISSY CRAMAYEL (FR); Stéphane PETIBON, MOISSY CRAMAYEL (FR); Florent ROUGIER, MOISSY CRAMAYEL (FR)

(21) Appl. No.: 17/916,348

(22) PCT Filed: Mar. 23, 2021
(86) PCT No.: PCT/FR2021/050492

§ 371 Date: Apr. 12, 2023

(30) Foreign Application Priority Data
Apr. 1, 2020 (FR) 2003257

(51) Int. Cl. B64D 27/33; B64D 27/18; B64D 27/31; B64D 27/357

(52) U.S. Cl. CPC B64D 27/33; B64D 27/18; B64D 27/31; B64D 27/357; B64D 2221/00

(57) ABSTRACT

The invention relates to a propulsion system (20) for a non-rotary-wing aircraft (3), the system comprising an alternating-current generator (24), at least one wingtip propulsion unit (22) comprising an alternating-current motor, and at least one lift-increase propulsion unit (23a-23d) comprising an alternating-current motor. The generator is connected to the lift-increase propulsion unit via a AC/DC converter (261), an intermediate DC distribution stage (260) provided with electric batteries (262) and a DC/AC converter (263a-263d). On the other hand, the generator is connected to the wingtip propulsion unit in such a way as to supply this propulsion unit with alternating current, without intermediate conversion of this alternating current into direct current.

The invention also relates to an aircraft provided with such a propulsion system.

### TECHNICAL FIELD OF THE INVENTION

The present invention relates to a propulsion system comprising propulsion units with electric motors, for a non-rotary-wing aircraft. It also relates to a non-rotary-wing aircraft provided with such a propulsion system, in particular a hybrid propulsion aircraft equipped with both turboprops and propulsion units with electric motors.

### TECHNOLOGICAL BACKGROUND OF THE INVENTION

For non-rotary-wing aircraft, an electric or hybrid propulsion is a particularly interesting alternative to propulsion carried out solely by turboprops.

Indeed, using an electric or hybrid propulsion unit in the take-off or landing phase may enable to reduce the emission of polluting gases in the vicinity of airports, and in the urban areas located nearby.

The use of electric propulsion units, as a complement or instead of turboprops, moreover facilitates the carrying out of advanced propulsion architectures comprising, for example additional wingtip propulsion units, that make it possible to reduce wingtip drag, or comprising one or more additional rear propulsion units, with BLI (Boundary Layer Ingestion), for example.

In this field, document US 2018/0118356 describes an aircraft of which the propulsion, of the “turbo-electric distributed” type, is carried out entirely thanks to electric propulsion units (with no turboprop). These propulsion units are distributed along the wings of the aircraft.

Some of these propulsion units, placed at the wingtip, are used as “flight control” propulsion units, to allow for a control of the direction of the aircraft. Their respective rotation speeds are finely controlled, propulsion unit by propulsion unit. The other propulsion units, called “thrust” propulsion units, are used to supply most of the thrust required for the flight of the aircraft. They are located between the “flight control” propulsion units and the fuselage of the aircraft.

The aircraft in question moreover comprises an alternating-current generator driven by a turbine (turbine not provided with a propeller), for the power supply of the electric motors of the propulsion units.

The motors of the “thrust” propulsion units are powered directly by this generator, with no intermediate converter, which limits the losses in the power supply circuit.

Regarding “flight control” propulsion units, they are electrically connected to the generator via an intermediate stage operating with DC current. Each “flight control” propulsion unit is connected to this intermediate stage via a DC/AC converter (which converts direct current into alternating current), in such a way that the propulsion unit in question is finally powered with alternating current. This structure, with an intermediate conversion in the form of direct current, makes it possible to finely control the rotation speed of the “flight control” propulsion units, independently of one another (and independently of the rotation speed of the turbine), thanks to which a control of the direction of the aircraft is obtained.

But with the propulsion system described hereinabove, the emission of polluting gases during take-off, landing and taxi phases remains substantial (since the turbine is necessarily operating, during these phases, to electrically power the “thrust” propulsion units which supply most of the thrust).

### SUMMARY OF THE INVENTION

In this context, a propulsion system for a non-rotary-wing aircraft is proposed comprising:
an alternating-current generator,
at least one wingtip propulsion unit comprising an alternating-current motor, having a direction of rotation that opposes the formation of wingtip vortices,
at least one lift-increase propulsion unit, comprising an alternating-current motor,
a first AC power supply circuit, that electrically connects the generator to the wingtip propulsion unit, and
a second AC power supply circuit, that electrically connects the generator to the lift-increase propulsion unit,
wherein the second power supply circuit comprises:
   an intermediate DC distribution stage,
   one or more electric batteries connected to said intermediate DC distribution stage,
   an AC/DC converter, that electrically connects the generator to said intermediate DC distribution stage, and
   a DC/AC converter, that electrically connects said intermediate stage to the lift-increase propulsion unit,
and wherein the first power supply circuit is configured to deliver to the wingtip propulsion unit an AC current produced by the generator, without intermediate conversion of this alternating current into direct current.

Thanks to the intermediate DC distribution stage, and thanks to the converters of the second circuit, the lift-increase propulsion unit or units, the role of which is essential in the take-off phase, can be powered on a battery during this phase. This makes it possible, in a very interesting manner, to reduce the polluting gas emissions in airport zones and in the vicinity of the latter.

In addition, this particular structure of the second circuit makes it possible to electrically adjust the rotation speed of the lift-increase propulsion unit or units with much flexibility, independently of the rotation speed of the generator (which, in practice, is driven by a turbine). This therefore makes it possible to adjust the lift-increase with flexibility, thus authorising quick, one-off changes in altitude, which increases the agility of the aircraft.

Moreover, connecting the wingtip propulsion unit or units to the generator somewhat directly, without intermediate conversion into direct current, makes it possible to save a very substantial amount of fuel, over the entire typical flight of the aircraft.

This reduction in overall consumption can appear to be surprising at first glance, because the role of wingtip propulsion units a priori seems secondary, in the propulsion of the aircraft (such propulsion units moreover play a secondary role, in document US 2018/0118356). But in fact, wingtip propulsion units make it possible to substantially reduce wingtip drag (due to the formation of wingtip vortices), drag which notably participates in the total drag that the aircraft is subjected to. It is therefore desirable to operate these wingtip propulsion units almost constantly (and to confer upon them a notable role in the propulsion of the aircraft), and therefore, in light of the practically permanent nature of their operation, to minimise the electrical losses in their power supply circuit and to thus increase the yield of the transmission chain and minimise the overall mass of this same chain. Here, this minimisation of the losses is obtained by the somewhat direct connection, without AC/DC conversion, between the generator and the wingtip propulsion unit or units.

It can in particular be provided that each lift-increase propulsion unit be positioned between: the wingtip propulsion unit or one of the wingtip propulsion units on the one hand, and a fuselage of the aircraft on the other hand.

The propulsion system that has just been presented can further comprise a turboprop. The generator mentioned hereinabove can then be driven by the turbine of this turboprop, for example.

This configuration makes it possible to further improve the overall energy consumption of the aircraft (consumption over an entire regional flight of a few hundred kilometres, for example).

Indeed, this configuration makes it possible, in the cruising or climbing phase, to ensure the propulsion of the aircraft thanks to the turboprop and to the wingtip propulsion unit while keeping the lift-increase propulsion unit or units off.

During these flight phases, which are particularly long and which consume much fuel, the losses that the AC/DC conversion would cause are thus avoided, in the second power supply circuit.

Formulated differently, thanks to the turboprop, the second power supply circuit, which induces additional electrical losses (but which in return allows for a low-polluting take-off and landing), is used only during a reduced duration, in the take-off or landing phase (or for quick variations in altitude).

In addition to the characteristics mentioned hereinabove, the propulsion system in accordance with the invention can have one or more additional characteristics among the following, taken individually or in any technically permissible combination:
the first power supply circuit and the second power supply circuit are connected to one another by an AC distribution stage, common to these two power supply circuits, the AC distribution stage itself being connected to the generator, the AC/DC converter of the second power supply circuit being connected between the AC distribution stage and the intermediate DC distribution stage;
the AC/DC converter is reversible, said converter allowing both a transfer of electric power from the AC distribution stage to the intermediate DC distribution stage, and from the intermediate DC distribution stage to the AC distribution stage;
the DC/AC converter of the second power supply circuit is reversible, said converter allowing both a transfer of electric power from the intermediate DC distribution stage to the lift-increase propulsion unit, and from the lift-increase propulsion unit to the intermediate DC distribution stage;
the propulsion system further comprises an electronic control unit that comprises at least one processor and one memory, the control unit being programmed to, during a flight of the aircraft comprising, inter alia, a take-off phase, a cruising phase and a landing phase, control the motor of the lift-increase propulsion unit in such a way that this propulsion unit:
   delivers a mechanical propulsion power in the take-off and/or landing phase,
   but remains off during most of the cruising phase;
the control unit of the propulsion system is programmed to, during most of the flight of the aircraft, control the motor of the wingtip propulsion unit to deliver a mechanical propulsion power;
the lift-increase propulsion unit comprises a fixed-pitch propeller;
the wingtip propulsion unit comprises a variable-pitch propeller.

Another aspect of the invention relates to a non-rotary-wing aircraft comprising:
a fuselage, a left wing that extends to the left of the fuselage and a right wing that extends to the right of the fuselage,
a first propulsion system and a second propulsion system, such as described hereinabove,
the wingtip propulsion units of the first and second propulsion systems being located respectively at the tip of the left wing and at the tip of the right wing, or inversely,
the lift-increase propulsion units being located between the fuselage of the aircraft and the wingtip propulsion units.

The aircraft that has just been presented can further have one or more additional characteristics among the following, taken individually or in any technically permissible combination:
the first propulsion system and the second propulsion system each comprise a turboprop;
the turboprop of the first propulsion system, which drives the generator of the first propulsion system, is located on the left of the fuselage while the wingtip propulsion unit of the first propulsion system is located at the tip of the right wing of the aircraft;
the turboprop of the second propulsion system, which drives the generator of the second propulsion system, is located on the right of the fuselage, while the wingtip propulsion unit of the second propulsion system is located at the tip of the left wing of the aircraft;
the first propulsion system comprises at least two lift-increase propulsion units, one located on the left and the other located on the right of the fuselage, these two lift-increase propulsion units being both electrically connected to the intermediate DC distribution stage of the first propulsion system;
the second propulsion system comprises at least two lift-increase propulsion units, one located on the left and the other located on the right of the fuselage, these two lift-increase propulsion units being both electrically connected to the intermediate DC distribution stage of the second propulsion system;
each wingtip propulsion unit and each lift-increase propulsion unit is electrically connected on the one hand to the generator of the first propulsion system and on the other hand to the generator of the second propulsion system in such a way as to be electrically powered indifferently either by one or by the other of these two generators; this makes it possible to continue electrically powering the various electric propulsion units even in case of failure of one of the generators or of one of the turbines driving these generators.

The invention and its various applications will be better understood when reading the following description and in examining the accompanying figures.

### BRIEF DESCRIPTION OF THE FIGURES

The figures are presented for the purposes of information and in no way limit the invention.

FIG. 1 schematically shows a non-rotary-wing aircraft according to a first embodiment, seen from above.

FIG. 2 schematically shows a non-rotary-wing aircraft according to a second embodiment, seen from above.

FIG. 3 is a partial schematic view of a non-rotary-wing aircraft according to a third embodiment, showing a first propulsion system of this aircraft, seen from above.

FIG. 4 is a partial schematic view of the aircraft of FIG. 3, showing a second propulsion system of this aircraft, seen from above.

FIG. 5 schematically shows a non-rotary-wing aircraft according to a fourth embodiment, seen from above.

FIG. 6 schematically shows, for various propulsion units of an aircraft such as that of one of FIGS. 1 to 5, at what moment each one of these propulsion units is a motor, or generator, or is off, during a typical flight of the aircraft.

### DETAILED DESCRIPTION

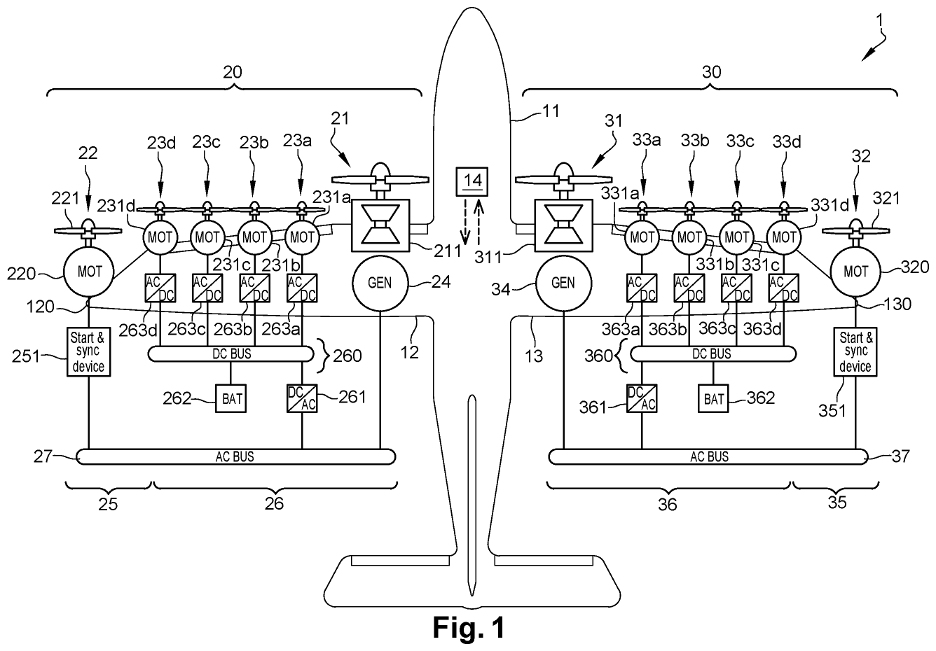

FIGS. 1 to 5 show four different embodiments of a non-rotary-wing aircraft 1; 2; 3; 4 implementing the teachings of the invention.

Regardless of the embodiment considered, the aircraft 1; 2; 3; 4 comprises a fuselage 11 that extends along a median longitudinal axis of the aircraft, a left wing 12 that extends to the left of the fuselage 11, and a right wing 13 that extends to the right of the fuselage 11.

The left 12 and right 13 wings can be separate from one another. But they can also together form a wing element of a single piece, which presents a continuous surface to the air extending from the free end 120 of the left wing to the free end 130 of the right wing (in this case, the expression left wing designates the portion of this wing element that extends to the left of the fuselage, and the same applies for the expression right wing).

In each one of the embodiments shown, the aircraft 1; 2; 3; 4 is provided with a first propulsion system 20; 20′ and with a second propulsion system 20; 30′, for example a left propulsion system 20 and a right propulsion system 30, as in the case of FIG. 1.

These propulsion systems, described in detail hereinbelow, are well suited, among others, to the cases where the aircraft 1; 2; 3; 4 is a passenger (or cargo) plane of the “commuter” type (plane typically comprising less than 50 passenger seats and weighing less than 20 tonnes), intended for carrying out flights of the regional type of a few hundred kilometres.

In any case, these propulsion systems can also equip a long take-off aircraft as well as a short take-off aircraft.

Such as shown, the first propulsion system 20; 20′ and the second propulsion system 30; 30′ of the aircraft each comprise:
a turboprop 21, 31,
a wingtip propulsion unit 22, 32, with alternating-current motor, here a polyphase motor,
at least one, here N lift-increase propulsion units 23a, 23b, 23c, 23d, 33a, 33b, 33c, 33d, with an alternating-current motor, here a polyphase motor,
an alternating-current generator 24, 34, here polyphased, driven by the turboprop 21, 31 and which makes it possible to electrically power the electric propulsion units mentioned hereinabove, and
an electricity distribution system, that connects the generator 24, 34 to the electric propulsion unit in question.

Here, for each one of the first 20; 20′ and second propulsion systems 30; 30′, the number N of lift-increase propulsion units 23a, 23b, 23c, 23d, 33a, 33b, 33c, 33d is equal to four.

The turboprop 21 of the first propulsion system 20; 20′ is located on the left of the fuselage 11, while the turboprop 31 of the second propulsion system 30; 30′ is located on the right of the fuselage 11. Here, these turboprops are fixed to the left and right wings 12, 13 of the aircraft.

The propulsion of the aircraft 1; 2; 3; 4, carried out both by means of turboprops 12, 13 and by means of electric propulsion units 22, 23a, 23b, 23c, 23d, 32, 33a, 33b, 33c, 33d, is therefore a hybrid propulsion.

Among the various propulsion units of the aircraft, the wingtip propulsion units 22, 32 are those which are located closest to the wingtips 12, 13 of the aircraft (i.e. closest to the free ends 120, 130 of these wings). They can for example be positioned in such a way that their motor axis is located at a distance from the free end 120, 130 of the wing considered which is less than the diameter of the propeller 220, 320 of this propulsion unit, even less than the radius of this propeller. The propeller 220, 320 of this propulsion unit can be protruding from the wing (the axis of the propulsion unit then being aligned with the free end 120, 130 of the wing, for example).

The wingtip propulsion units 22, 32 make it possible to reduce the wingtip drag, due to the formation of a wingtip vortex. It is provided here, during a typical flight of the aircraft, to operate these propulsion units during most of the flight. Their respective directions of rotation are chosen in such a way as to oppose the wingtip vortex, that is formed at the wingtip 12, 13 on which they are mounted.

As for the lift-increase propulsion units 23a, 23b, 23c, 23d, 33a, 33b, 33c, 33d, they are distributed along wings 12, 13 of the aircraft, between the wingtip propulsion units 22, 32 and the fuselage 11. Here, the lift-increase propulsion units are more precisely distributed between the wingtip propulsion units 22, 32 and the turboprops 21, 31.

The lift-increase propulsion units make it possible, by modifying the airflow over and under the wings 12, 13 of the aircraft, to increase the lift-increase of the aircraft (which moreover explains that they are positioned fully on the wing considered, not at its end). Such as shown in the figures, the lift-increase propulsion units drive propellers which are located upstream from the leading edge of the wing of the aircraft. Alternatively, these propellers could however be located downstream (or to the right) of this leading edge, for example under the wing in question. It is provided here, during a typical flight of the aircraft, to operate the lift-increase propulsion units mainly in the take-off, approach and landing phases, as well as during taxiing. It is provided that these propulsion units be off during most of the climbing and cruising phases (although they can be turned on for a short duration, during these phases, for example to allow for a quick increase in altitude).

Such as shown, the aircraft 1; 2; 3; 4 comprises four lift-increase propulsion units 23a-23d, 33a-33d on each wing 12, 13. Alternatively, each wing of the aircraft could however be provided with a different number of lift-increase propulsion units (for example, the number N of lift-increase propulsion units that equip each wing could be equal to 1, 2 or 3 or be higher than 4).

In the embodiments shown, the various electric propulsion units 22, 23a, 23b, 23c, 23d, 32, 33a, 33b, 33c, 33d are distributed along the wings 12, 13 of the aircraft. In other embodiments not shown, the aircraft could however further comprise one or more electric propulsion units located elsewhere than on the wings, for example at the rear of the fuselage.

Now that the overall arrangement of the aircraft 1; 2; 3; 4 and of the propulsion units has been presented, the particular electricity distribution system can be described, implemented in the aircraft to power the electric propulsion units 22, 23a, 23b, 23c, 23d, 32, 33a, 33b, 33c, 33d.

The differences between the first, second, third and fourth embodiments mainly concern this electricity distribution system. Here, with respect to the aircraft 1 of the first embodiment, the aircraft 2; 3; 4 of the second, third or fourth embodiment implements additional left-right cruising and/or redundancy arrangements between the two propulsion systems 20, 30; 20′, 30′, thanks to which a relatively symmetric thrust can be retained even in the case of malfunction of the left turboprop 21 or of the right turboprop 31.

Many technical characteristics are however common to these different embodiments. Thus, from one embodiment to another, identical or corresponding elements will as much as possible be marked with the same reference signs, and will not necessarily be described each time.

The propulsion systems of the aircraft, and in particular the manner of powering the electric propulsion units 22, 23a, 23b, 23c, 23d, 32, 33a, 33b, 33c, 33d are now described in more detail, embodiment by embodiment.

In the first embodiment (FIG. 1), the propulsion units 21, 22, 23a, 23b, 23c, 23d of the first propulsion system 20 are located to the left of the fuselage 11, while the propulsion units 31, 32, 33a, 33b, 33c, 33d of the second propulsion system 30 are located to the right of the fuselage 11.

In addition to its propulsion units and its alternating-current generator 24, the first propulsion system 20 (left propulsion system) comprises:
a first power supply circuit 25, that electrically connects its generator 24 to its wingtip propulsion unit 22, to supply it with electricity, and
a second power supply circuit 26, that electrically connects its generator 24 to its various lift-increase propulsion units, 23a, 23b, 23c, 23d, in order to be able to power them electrically.

The first power supply circuit 25 and the second power supply circuit 26 are both AC (alternating current) power supply circuits, in that they each deliver an electric power supply current of the alternating type, make it possible to power the alternating-current motors of the electric propulsion units of the aircraft.

However, remarkably, the second power supply circuit 26 comprises:
an intermediate DC distribution stage 260,
an AC/DC converter, 261, that electrically connects the generator 24 to the intermediate DC distribution stage 260, and
for each lift-increase propulsion unit 23a, 23b, 23c, 23d, a DC/AC converter 263a, 263b, 263c, 263d, of the inverter type, that electrically connects the lift-increase propulsion unit considered to the intermediate DC distribution stage 260.

An intermediate conversion, into direct current (DC), is therefore carried out between the generator 24, that supplies an alternating current (AC), and the lift-increase propulsion units 23a, 23b, 23c, 23d, which are equipped with electric motors 231a, 231b, 231c, 231d, also alternating current.

On the contrary, the first power supply circuit 25 is configured to deliver an AC current produced by the generator 24 to the wingtip propulsion unit 22, without intermediate conversion of this alternating current into direct current.

The first power supply circuit 25 is therefore devoid of an AC/DC or DC/AC converter.

The first power supply circuit 25 can however comprise, as here, one or more controlled contactors or switches, and one or more protective devices (protection against overvoltages, for example), not shown. Note however that these latter devices are not current or voltage converters. Indeed, they make it possible to establish, or to suspend, an electrical connection between different elements of a circuit, but they do not make it possible to transform the amplitude (or the value), the waveform, the direct or alternating nature, or the frequency of an electric current or voltage.

Here, the motor 221 of the wingtip propulsion unit 22 is an alternating-current motor, of the synchronous type. The first power supply circuit 25 is therefore provided with a starting and synchronisation device 251, connected between this motor and the generator 24, in order to allow this motor to start. In other embodiments, for which the motor of the wingtip propulsion unit would be a motor of the asynchronous type, this starting and synchronisation device could be omitted. In this latter case, the first power supply circuit would then be devoid of any type of current or voltage converter.

The first power supply circuit 25 and the second power supply circuit 26 are connected to one another by an AC distribution stage 27, common to these two power supply circuits 25 and 26. This distribution stage is carried out by means of contactors, protective devices, bus bars (i.e. high-current electric conductors, carried out in the form of bars or conductive plates of a single piece) and other electric conductors or connectors.

The generator 24 is connected, for example directly via electric conductors (without any intermediate device), to the AC distribution stage 27.

The starting and synchronisation device 251 of the wingtip propulsion unit 22 is also connected to this AC distribution stage 27 (for example connected directly via electric conductors, without any intermediate device).

Moreover, the AC/DC converter 261 of the second circuit is connected between this AC distribution stage 27, and the intermediate DC distribution stage 260.

It can be provided, as here, that this AC/DC converter 261 be reversible, allowing both a transfer of electric power from the AC distribution stage 27 to the intermediate DC distribution stage 260, and inversely.

The intermediate DC distribution stage 260 is carried out, as the AC distribution stage 27, by means of contactors, protective devices, bus bars and other electric conductors or connectors.

The DC/AC current converters 263a, 263b, 263c, 263d, that electrically connect the lift-increase propulsion units 23a, 23b, 23c, 23d to the intermediate DC distribution stage 260, can, as here, be reversible, i.e. authorise both a transfer of electrical power from the intermediate DC distribution stage 260 to the lift-increase propulsion unit considered, and inversely, from this propulsion unit to the intermediate stage 260.

Moreover, the second power supply circuit 26 is here provided with a device for storing electrical energy, here a battery or a set of electric batteries 262, connected to the intermediate DC distribution stage 260.

Regarding the mechanical aspects, the wingtip propulsion unit 22 is provided with one or more propellers, of which at least one is of variable pitch (i.e. a propeller of which the timing can be adjusted, during flight). This arrangement is interesting because the wingtip propulsion unit 22 is intended to operate during most of the flight of the aircraft, therefore over a particular extended range of displacement speeds, and because its rotation speed is imposed by that of the turboprop 21 (since the motor 221 is of the synchronous type, here).

As for the lift-increase propulsion units 23a, 23b, 23c, 23d, they are provided here with fixed-pitch propellers (i.e. of which the timing cannot be adjusted during flight). More precisely, their propeller, or all their propellers if they contain several, are of a fixed pitch. This makes it possible to advantageously simplify the structure of these propulsion units, for which the rotation speed can be adjusted with much more flexibility than for the wingtip propulsion unit 22 (thanks to the intermediate conversion into direct current).

Note that the term “propeller” here designates, generally, a propulsion member comprising blades fixed to a shaft, whether a streamlined propeller (sometimes called “fan”) or a non-streamlined propeller.

The second propulsion system 30 (right propulsion system) is here identical (or at the very least similar) to the first propulsion system 20. In addition to its propulsion units 31, 32, 33a-33d, and its alternating-current generator 34, the second propulsion system 30 therefore comprises:
a first power supply circuit 35, identical to the first circuit 25 that was described hereinabove, and
a second power supply circuit 36, identical to the second circuit 26.

The first circuit 35 thus comprises an AC distribution stage 37 (common to the second circuit 36), and a starting and synchronisation device 351 connected to the wingtip propulsion unit 32.

In addition, the second circuit 36 in particular comprises:
an intermediate DC distribution stage 360,
an AC/DC converter 361, here reversible, connected between the AC distribution stage 37 and the intermediate DC distribution stage 360,
for each lift-increase propulsion unit 33a-33d, a DC/AC converter 363a-363d, here reversible, that electrically connects the motor 331a-331d (alternating current) of the lift-increase propulsion unit considered, to the intermediate DC distribution stage 360, and
a set of electric batteries 362 connected to the intermediate stage 360.

The wingtip propulsion unit 32 of the second propulsion system 30 comprises (as for the first propulsion system) an alternating-current motor 321, here of the synchronous type, that drives one or more propellers, at least one of which, 320, is variable pitch.

The first propulsion system 20 and the second propulsion system 30 moreover comprise an electronic control unit, 14, that is common to them, here. This control unit 14 communicated with the motors, converters, contactors and other actuators of these two propulsion systems, and is able to control them.

The control unit 14 is programmed here to control the motors of the lift-increase propulsion units 23a, 23b, 23c, 23d, 33a, 33b, 33c, 33d, in such a way that these propulsion units deliver a mechanical propulsion power in the take-off, approach, landing phase, and even in the taxi phase, with these propulsion units being powered at least partially, here entirely, by the electric batteries 262, 362, during the flight or displacement phases in question.

This arrangement makes it possible to reduce the emission of polluting gases, during these flight and displacement phases, since a portion of the power required for the propulsion of the aircraft is then supplied by the electric batteries 262, 362, which makes it possible to reduce by as much the power that the turboprops have to supply in order for the aircraft to take off or land. The atmospheric pollution in the airport zones, and in the vicinity of the latter is thus advantageously reduced.

The control unit 14 is also programmed to control the motors of the lift-increase propulsion units 23a, 23b, 23c, 23d, 33a, 33b, 33c, 33d in such a way that these propulsion units remain off during most of the cruising phase, and even climbing phase, during a flight of the aircraft.

This arrangement is interesting in terms of fuel consumption. Indeed, in order to operate the lift-increase propulsion units 23a, 23b, 23c, 23d, 33a, 33b, 33c, 33d throughout a cruising phase, it would be necessary to power them with electricity by means of generators 24, 34, because the storage capacities of the electric batteries 262, 362 are necessarily limited (in order to avoid excessive weight of the aircraft), and because a substantial part of the initial load of these batteries is consumed in the take-off phase. However, taking a portion of the mechanical power produced by the turbines 211, 311 of the turboprops 21, 31, in order to convert it into electricity so as to then power the lift-increase propulsion units generally consumes more than directly using this mechanical power to drive the propellers of the turboprops (in any case for the entire cruising phase, during which the average altitude of the aircraft is constant).

The control unit 14 is programmed moreover to, during most of the cruising phase of a flight of the aircraft, even also during most of the climbing phase of this flight, control the motors 221, 321 of the wingtip propulsion units 22, 32 to deliver a mechanical propulsion power.

The control unit 14 can even be programmed, as here, to control the motors 221, 321 of the wingtip propulsion units 22, 32 to deliver a mechanical propulsion power throughout the take-off, climbing, cruising and landing phases of the aircraft (during the descent phase, the wingtip propulsion units can on the other hand be controlled so as to operate as mechanical power receivers, and therefore as an electric generator).

These arrangements are interesting also in terms of fuel consumption. Indeed, although the mechanical/electrical conversion (by the generators) then electrical/mechanical conversion (by the motors of the wingtip propulsion units) is accompanied by losses, the wingtip propulsion units 22, 32 allow for a substantial reduction in wingtip drag, drag that notably participates in the total drag that the aircraft is subjected to.

The importance of reducing the power losses as much as possible in the first electric circuits 25, 35, that connect the generators 24, 34 to the wingtip propulsion units 22, 32 is however understood, since these propulsion units operate and deliver a mechanical propulsion power during most of the flight of the aircraft. It is moreover for limiting these losses as much as possible that a somewhat direct electrical connection is used, without AC/DC conversion, between the generators and the wingtip propulsion units.

To summarise, the architecture of the first and second propulsion systems 20, 30 makes it possible:
by operating the wingtip propulsion units during most of the flight of the aircraft, with a “direct” generator-propulsion unit connection (without AC/DC conversion), to reduce the overall fuel consumption over this entire flight (in particular with respect to an aircraft comprising only turboprops), and
by powering the lift-increase propulsion units with batteries during the take-off, landing and taxi phases (which is made possible by the structure of the second circuits 26, 36, with intermediate DC stage), to reduce the atmospheric pollution in the airport zone.

Furthermore, powering the lift-increase propulsion units 23a-23d, 33a-33d via the intermediate DC distribution stages 260, 360 and the DC/AC current converters 263a-263d, 363a-363d makes it possible to electrically control the rotation speed of these propulsion units with much flexibility (in particular, independently of the rotation speeds of the turboprops 21, 31). This in particular makes it possible to not need variable-pitch propellers, for these propulsion units, thus simplifying their structure.

The intermediate DC distribution stages 260, 360 of the second circuits 26, 36, provided with batteries, and the reversible nature of the DC/AC current converters 263a-263d, 363a-363d, moreover make it possible, in the descent phase of the aircraft, to recover mechanical energy (by operating the lift-increase propulsion units as mechanical receivers-somewhat as air turbines, according to the expression “windmilling”) and to store the energy recovered in electrical form, in the electric batteries 262, 362, as is explained hereinbelow.

Different operating modes of the first and second propulsion systems 20, 30, associated with different flight or operating phases of the aircraft shall now be described in more detail.

Here, the control unit 14 is programmed in particular to control the first and second propulsion systems 20, 30 in such a way as to implement one or the other of these operating modes (according to the flight phase of the aircraft). In particular, the control unit 14 can be programmed in such a way as to:
select one or the other of these operating modes according to data received by this control unit, representative of the flight phase in progress (with this piece of data specifying for example that the phase in progress is a take-off phase, or on the contrary a cruising phase) and/or representative of a control choice of a pilot of the aircraft or of an onboard computer of the aircraft and/or representative of a state of the aircraft (for example a state of charge of its propulsion batteries 262, 362), and
control the various actuators (motors, converters, contactors, etc.) of the propulsion systems 20, 30 in accordance with the operating mode thus selected.

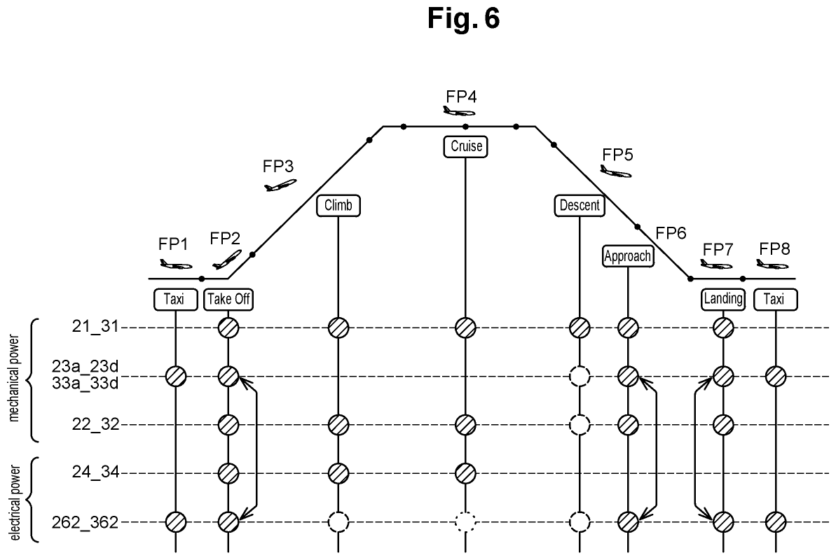

FIG. 6 diagrammatically shows various phases of a typical flight of the aircraft 1, referenced as FP1 to FP8, versus time t. FIG. 6 also shows, by way of a chronogram, for the various propulsion units of the aircraft, the phases during which each one of these propulsion units is a motor (and possibly receiver), during this flight.

As can be seen in this figure, the flight in question successively comprises (in this order):
a taxi phase FP1,
a take-off phase FP2,
a climbing phase FP3,
a cruising phase FP4,
a descent phase FP5,
an approach phase FP6,
a landing phase FP7, and
another taxiing phase for the displacement on the ground FP8.

In FIG. 6, for each phase, and for each propulsion unit, a grey disc indicates that the propulsion unit considered is operating as a “motor”, i.e. supplies a mechanical propulsion power, during the phase in question. A white disc (i.e. a black circle, possibly as a dotted or dashed line, filled with white) on the contrary indicates that the propulsion unit is operating as a mechanical power receiver (as a generator), during the phase in question, while an absence of a disc indicates that the propulsion unit is off (does not exchange energy) during most of this phase.

A similar convention is used for the sources of electrical energy, i.e. the generators 24, 34 and the electric batteries 262, 362. A grey disc indicates that the source considered is outputting, during the flight or displacement phase considered, a white disc indicates that this source is receiving electrical power (positive), and an absence of a disc indicates that this source is not outputting and is not receiving any electrical power.

For some phases (climbing phase FP3 and descent phase FP5), a disc surrounded by a dotted line indicates that the associated energy exchange is optional (or that it may take place only during a portion of the phase considered).

For the cruising phase FP4, the white disc surrounded by a dotted line indicates that the energy exchange in question (recharging of the electric batteries) takes place only during a portion of the cruising phase.

The operating modes associated with these various flight phases are now described one by one.

In the operating mode corresponding to the taxiing phase for displacement on the ground FP1, or FP8, the displacement of the aircraft 1 is provided by the lift-increase propulsion units 23a-23d, 33a-33d, electrically powered by the electric batteries 262, 362. As for the turboprops 21, 31 and wingtip propulsion units 22, 32, they are off, in this operating mode.

In the operating mode corresponding to the take-off phase FP2, the various propulsion units of the aircraft, 21, 22, 23a-23d, 31, 32, 33a-33d participate in the propulsion thereof. The lift-increase propulsion units 23a-23d, 33a-33d are electrically powered by the electric batteries 262, 362 and also possibly by the generators. The wingtip propulsion units 22, 32 are electrically powered by the generators 24, 34 (driven by the turboprops).

In the operating mode corresponding to the climbing phase FP3, the propulsion of the aircraft is ensured by the turboprops 21, 31, and by the wingtip propulsion units 22, 32 which are electrically powered by the generators 24, 34. As for the lift-increase propulsion units 23a-23d, 33a-33d, they are off. In this operating mode, the electric batteries (partially emptied during take-off) are recharged by the generators optionally, or, at the very least, these batteries are not outputting.

In the operating mode corresponding to the cruising phase FP4, the propulsion of the aircraft is provided by the turboprops 21, 31, and by the wingtip propulsion units 22, 32 which are electrically powered by the generators 24, 34. As for the lift-increase propulsion units 23a-23d, 33a-33d, they are off (except possibly during brief altitude change phases). In this operating mode, the electric batteries (partially emptied during take-off) are recharged by the generators, then, once these batteries are full, they no longer intervene in the exchanges of energy. It can also be provided, during the cruising or climbing phase, to stop charging batteries before they reach their maximum charge in order to retain a storage margin, in order to, during the descent, be able to store in electrical form a mechanical energy recovered by the electric propulsion units operating as receivers.

In the operating mode corresponding to the descent phase FP5, the propulsion of the aircraft is provided here by the turboprops 21, 31. During at least a portion of the descent, it is provided here that the wingtip propulsion units 22, 32 and the lift-increase propulsion units 23a-23d, 33a-33d operate as receivers, optionally, and that the energy that they recover is stored in the batteries. This recovery of energy in electrical form is made possible in particular by the reversible nature of the DC/AC current converters 263a-263d, 363a-363d. During this entire period, the generators 24, 34 are not outputting. During the descent, when the electric propulsion units are not operating as receivers (for example because the batteries are full), it is provided here to not supply them with electrical energy.

In the operating mode corresponding to the approach phase FP6, and to the landing phase FP7, the various propulsion units of the aircraft, 21, 22, 23a-23d, 31, 32, 33a-33d participate in the propulsion thereof. During these phases, the lift-increase propulsion units 23a-23d, 33a-33d are electrically powered by the electric batteries 262, 362 and also possibly by the generators. The wingtip propulsion units 22, 32 are powered by the generators 24, 34 (driven by the turboprops). During this phase, the lift-increase propulsion units 23a-23d, 33a-33d can participate in the generating of inverse thrust for the braking of the aircraft. While the wingtip propulsion units 22 and 32 can make it possible to partially compensate the thrust in order to control and/or increase the manoeuvring capacity of the aircraft, in particular in case of a crosswind or disturbance by unwanted air movements.

These various operating modes, and the flight phases that they are associated with are described by way of example, and various modifications can made thereto.

Thus, it could be provided for example that the wingtip propulsion units 22, 32 be electrically powered by the generators 24, 34, during the descent phase, or during a portion of this phase.

It could also be provided that the wingtip propulsion units 22, 32 be electrically powered by the generators 24, 34, or possibly be off, in the approach and landing phase.

The control unit 14 can also be programmed to implement a specific operating mode, for starting wingtip propulsion units 22, 32. In this operating mode, the wingtip propulsion units 22, 32 are started (on the ground) or restarted (in flight) thanks to the electric batteries 262, 362 (and thanks to the reversible nature of the converters 261, 361). This arrangement is interesting because it makes it possible to simplify the starting and synchronisation device 251, 351 (or the structure of the motors of these propulsion units). Indeed, by starting the motors of the wingtip propulsion units 22, 32, here of the synchronous type, thanks to the electric batteries 262, 362 and to the converters 261, 361, the problem of synchronisation at start-up between these motors and the generators 24, 34 is eliminated. And once the rotation speed of these motors is close to that of the generators, power supply is switched to the generators.

The control unit 14 can also be programmed to implement another specific operating mode, for starting turboprops 21, 31, when the generators 24, 34 are reversible and can operate as motors (as electric starters). In this case, the generators are electrically powered by the electric batteries 262, 362, thanks to the reversible nature of the converters 261, 361, in such a way as to start the turboprops.

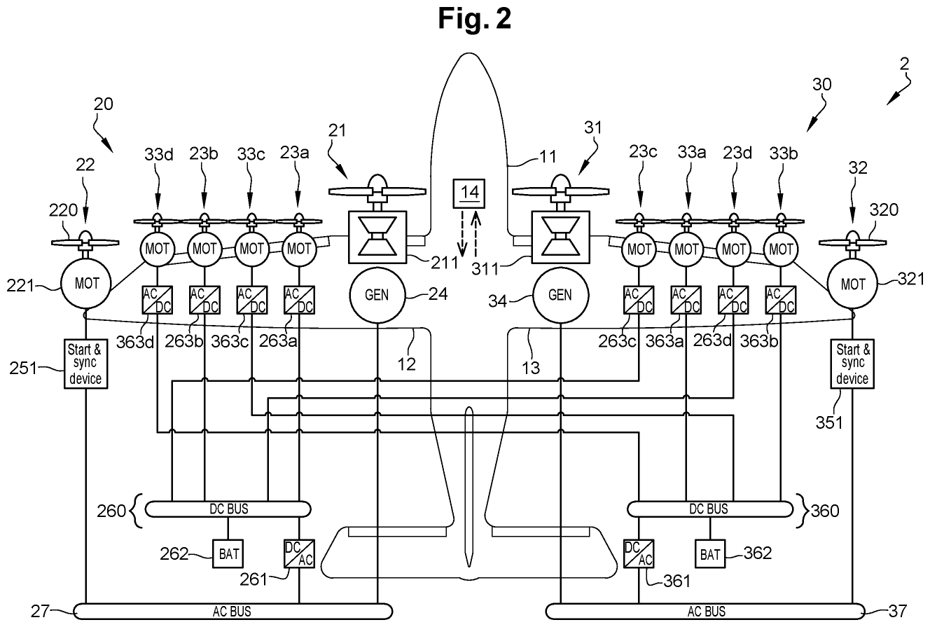

The aircraft 2 according to the second embodiment (FIG. 2) differs from the aircraft 1 of the first embodiment (FIG. 1) in that:
certain lift-increase propulsion units 23c, 23d of the first propulsion system 20 are fixed to the right wing 13 of the aircraft 2, while the other propulsion units 21, 23a, 23b, 22 of this first system 20 are fixed to its left wing 12 (while in the first embodiment, all the propulsion units of the first propulsion system are fixed to the same wing, the left), and in that
certain lift-increase propulsion units 33c, 33d of the second propulsion system 30 are fixed to the left wing 12 of the aircraft 2, while the other propulsion units 31, 33a, 33b, 32 of this second system 30 are fixed to its right wing 13 (while in the first embodiment, all the propulsion units of the first propulsion system are fixed to the same wing, the left),

Here, for each one of these two propulsion systems 20, 30, among the four lift-increase propulsion units of the propulsion system considered, two are fixed on the right wing 13, and two are fixed on the left wing 12, in such a way that these four propulsion units 23a-23d, or 33a-33d, form a symmetrical set with respect to a median sagittal plane of the aircraft 2 (left-right symmetry, including for the position of the propulsion units with respect to the fuselage).

This arrangement can be implemented in the same way when the number N of lift-increase propulsion units of each wing is a number different from 4, the number N preferably being an even number (for example equal to 2 or to 6). In this case, for each one of the two propulsion systems, N/2 lift-increase propulsion units are fixed to the left wing while the N/2 other lift-increase propulsion units are fixed to the right wing, preferably symmetrically with respect to the N/2 propulsion units of the left wing.

This sort of left-right crossing between the two propulsion systems 20, 30 makes it possible, in case of malfunction of the left turboprop 21 or of the right turboprop 31, to prevent an excessive dissymmetry between the lift-increase and thrust exerted respectively on the left side, and on the right side of the aircraft 2.

Indeed, if the right turboprop 31 becomes inoperative (no longer rotates), for example, it will still be possible, thanks to this left-right “crossing”, to electrically power a portion of the propulsion units of the right wing (the propulsion units 23c, 23d), with the left generator, 24. Thus, the aircraft can be propelled, on the left, by the left turboprop 21 and the electric propulsion units 22, 23a and 23b, and, on the right, by the electric propulsion units 23c and 23d (and this even when the electric batteries 362 are empty), thus preventing an excessive thrust dissymmetry between the left and the right of the aircraft.

For the rest, the aircraft 2 of the second embodiment is identical to the aircraft 1 of the first embodiment.

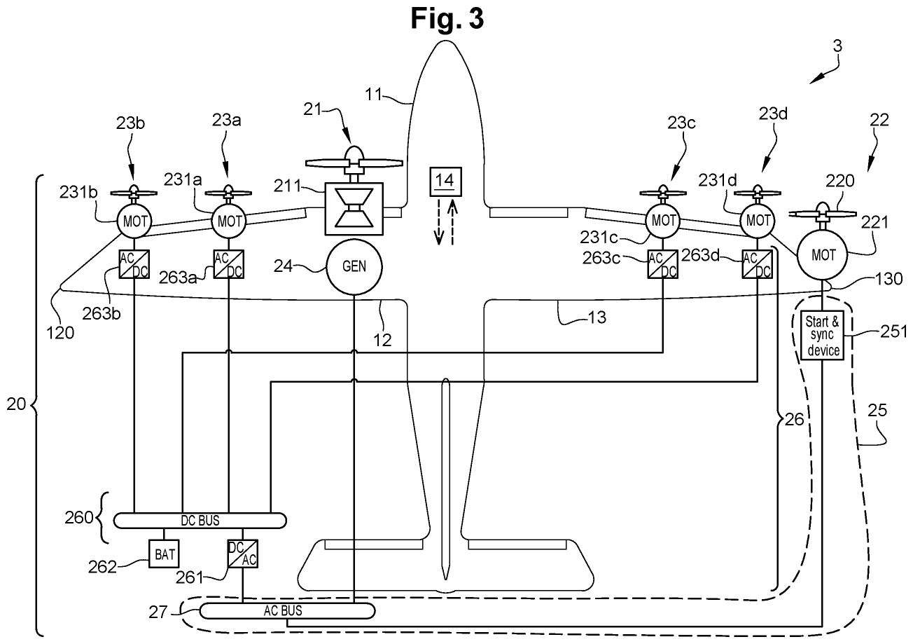

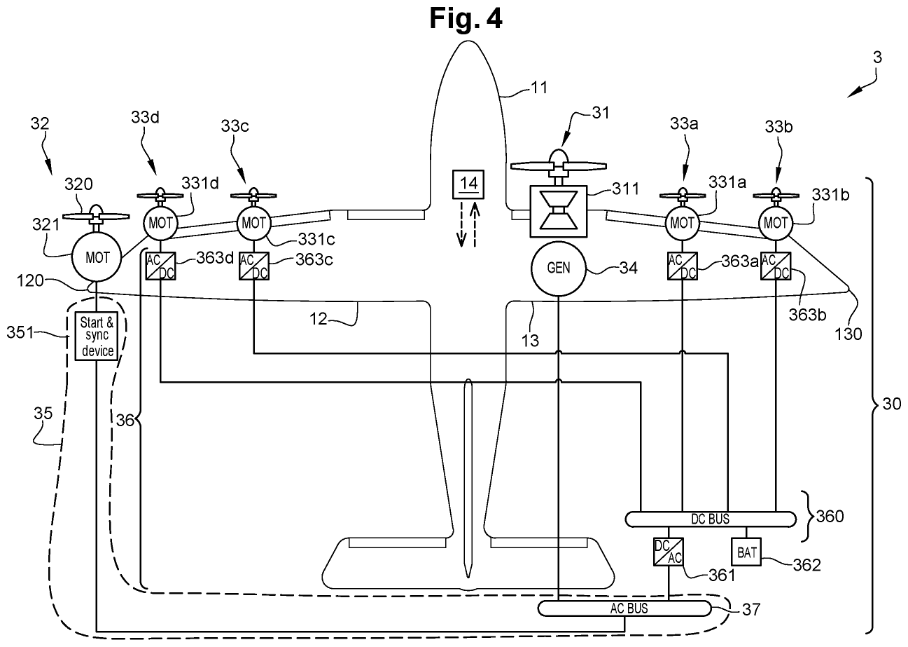

The aircraft 3 according to the third embodiment (FIGS. 3 and 4) is identical to the aircraft 2 of the second embodiment (FIG. 2), except, in this third embodiment:
the wingtip propulsion unit 22 of the first propulsion system 20 (“left” system) is fixed at the tip of the right wing 13,
while the wingtip propulsion unit 32 of the second propulsion system 30 (“right” system) is fixed to the tip of the left wing 12.

For increased clarity, in FIG. 3, the aircraft 2 and its first propulsion system 20 have been shown, but without showing the second propulsion system 30. And in FIG. 4, the aircraft 2 and its second propulsion system 30 have been shown, but without showing the first propulsion system 20.

In this third embodiment, the left-right “crossing” between the first and second propulsion systems therefore relates to a higher number of propulsion units than in the second embodiment, which makes it possible to further improve the left-right symmetry of the thrust (and of the lift-increase), in a case where one of the turboprops 21, 31 were to become inoperative.

Thus, if the turboprop 31 becomes inoperative, for example, the propulsion of the aircraft can still be provided: on the left, by the left turboprop 21 and the electric propulsion units 23a and 23b, and, on the right, by the electric propulsion units 23c, 23d, and 22.

Note that the aircraft could be carried out according to another embodiment, not shown, wherein
the wingtip propulsion unit of the first propulsion system (“left” system) would be fixed at the tip of the right wing, while the wingtip propulsion unit of the second propulsion system (“right” system) would be fixed at the tip of the left wing (as in the third embodiment),
but wherein all the lift-increase propulsion units of the first system would be located at the left of the fuselage, while all the lift-increase propulsion units of the second system would be located on the right of the fuselage.

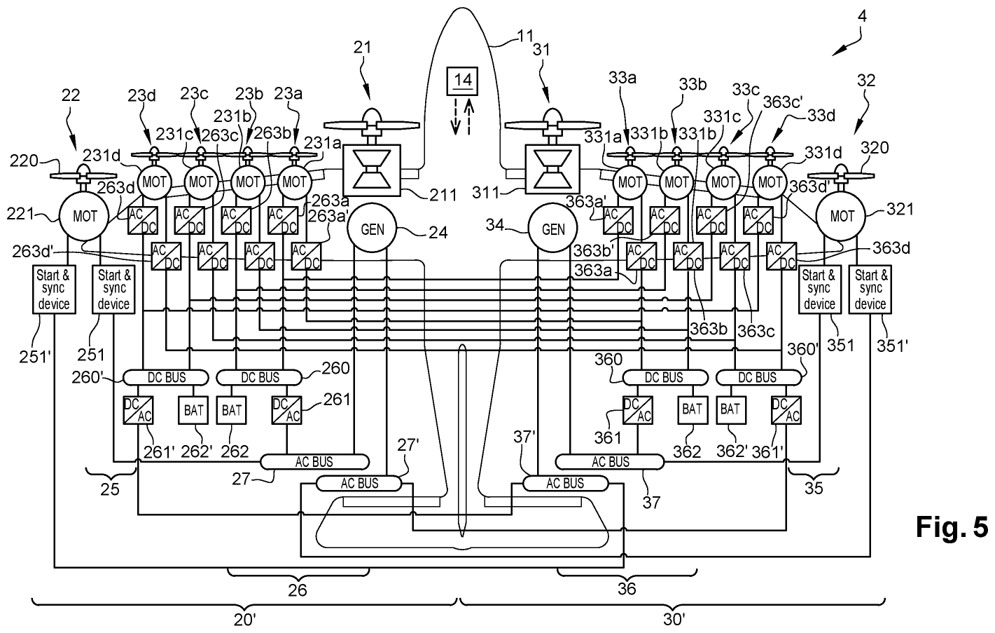

In the fourth embodiment of the aircraft 4 (FIG. 5), each electric propulsion unit comprises two inputs (more precisely two sets of input terminals), which makes it possible to electrically power this propulsion unit either with one, or with the other of these two inputs. One of these two inputs is electrically connected to the generator 24 of the first propulsion system 20′ while the other input is electrically connected to the generator 34 of the second propulsion system 30′, in such a way as to be able to electrically power the propulsion unit considered either by one or by the other of these two generators 24, 34.

Thanks to this arrangement, even if one of the turboprops becomes inoperative, all the electric propulsion units of the aircraft 4 can still be electrically powered, by the generator of the other propulsion unit, which makes it possible to retain a relatively symmetric thrust (and a lift-increase) between the left and the right of the aircraft (and this even if the electric batteries are empty).

Moreover, for the first, as for the second propulsion system 20′, 30′, the AC distribution stage 27, 37, the intermediate DC distribution stage 260, 360, the electric batteries 262, 362 and the converters 261, 263a-263d, 361, 363a-363d of the propulsion system are duplicated. This redundancy further improves the reliability of the aircraft.

In addition to the elements mentioned hereinabove, the first propulsion system 20′ therefore comprises (FIG. 5):
an additional AC distribution stage 27′, an additional intermediate DC distribution stage 260′,
one or more additional electric batteries 262′,
an additional AC/DC converter 261′,
for each lift-increase propulsion unit 23a-23d, an additional DC/AC converter 263a′-263d′, and
an additional starting and synchronisation device 251′.

In the same way, the second propulsion system 30′ comprises, in additional to the elements already mentioned:
an additional AC distribution stage 37′,
an additional intermediate DC distribution stage 360′,
one or more additional electric batteries 362′,
an additional AC/DC converter 361′,
for each lift-increase propulsion unit 33a-33d, an additional DC/AC converter 363a′-363d′, and
an additional starting and synchronisation device 351′.

For each lift-increase propulsion unit 23a-23d, 33a-33d, one of the two inputs of the propulsion unit is connected to the DC/AC converter 263a-263d, 363a-363d while the other input is connected to the additional DC/AC converter 263a′-263d′, 363a′-363d′.

For each wingtip propulsion unit 22, 32, one of the two inputs of the propulsion unit is connected to the starting and synchronisation device 251, 351 while the other input is connected to the additional starting and synchronisation device 251′, 351′.

As hereinabove, in the first propulsion system 20′, the AC distribution stage 27 is connected, on the one hand to the generator 24, and on the other hand to the intermediate DC distribution stage 260 (via the converter 261) as well as to the wingtip propulsion unit 22 of the left wing (via the starting device 251). The intermediate stage DC, 260, powers two lift-increase propulsion units 23a, 23b of the left wing 12, and two lift-increase propulsion units 33a, 33b of the right wing (via the converters 263a, 263b, 363a′, 363b′).

The additional AC distribution stage 27′ is also connected to the generator 24. It is connected moreover to the wingtip propulsion unit 32 of the right wing 13 (via the additional starting and synchronisation device 351′) as well as to the additional intermediate DC stage, 360′ (via the additional AC-DC converter 361′).

The additional intermediate DC stage 260′ is connected to the additional AC distribution stage 37′ of the second propulsion system 30′, via the additional AC-DC converter 261′. The additional intermediate stage DC 260′ electrically powers two lift-increase propulsion units 23c, 23d of the left wing 12, and two lift-increase propulsion units 33c, 33d of the right wing (via the converters 263c, 263d, 363c′, 363d′).

The additional starting device 251′ of the wingtip propulsion unit 22 of the left wing is also connected to the additional AC distribution stage 37′ of the second propulsion system.

The elements of the second propulsion system 30′ are connected together, and to those of the first propulsion system 20′, in the same way as what has just been presented for the first system 20′.

Thus, in the second propulsion system 30′, the AC distribution stage 37 is connected, on the one hand to the generator 34, and on the other hand to the intermediate DC distribution stage 360 (via the converter 361) as well as to the wingtip propulsion unit 32 of the right wing (via the starting device 351). The intermediate DC stage, 360, powers two lift-increase propulsion units 23a, 23b of the left wing 12, and two lift-increase propulsion units 33a, 33b of the right wing (via the converters 263a′, 263b′, 363a, 363b).

The additional AC distribution stage 37′ is connected to the generator 34. It is connected moreover to the wingtip propulsion unit 22 of the left wing 12 (via the additional starting and synchronisation device 251′) as well as to the additional intermediate DC stage, 260′ (via the additional AC-DC converter 261′).

The additional intermediate DC stage 360′ is connected to the additional AC distribution stage 27′ of the first propulsion system, via the additional AC-DC converter 361′. The additional intermediate DC stage 360′ electrically powers two lift-increase propulsion units 23c, 23d of the left wing 12, and two lift-increase propulsion units 33c, 33d of the right wing (via the converters 263c′, 263d′, 363c, 363d).

Different alternatives can be made to the embodiments that have just been described, in addition to those already mentioned, and other embodiments of the aircraft, or of the propulsion systems can be considered.

For example, the first and second propulsion systems could comprise a non-propulsive turbine, instead of a turboprop, the generator of each propulsion unit then being driven by the turbine (non-propulsive) of this system. The way of controlling the propulsion systems would then be different from what was presented hereinabove (in reference to FIG. 6). Indeed, due to the absence of a turboprop, it would be necessary in this case to operate the lift-increase propulsion units during a substantial portion of the climbing or cruising phases (even during the entire duration of these phases).

Moreover, instead of equipping an aircraft with two propulsion systems such as described hereinabove, each provided with a turbine, an aircraft could be equipped with a single propulsion system, comprising:
exactly one turbine, which is for example the turbine of a turboprop located at the front of the fuselage,
two wingtip propulsion units, one fixed at the tip of the left wing and the other fixed at the tip of the right wing,
and, on each wing, one or more lift-increase propulsion units, located between the fuselage and the wingtip propulsion unit of this wing.

In this last propulsion system, the two wingtip propulsion units would be connected to the generator (unique) in such a way as to be able to be powered by the latter without intermediate AD/DC conversion, as hereinabove. And the lift-increase propulsion units would on the contrary be connected to this generator via AC/DC and AC converters, and via one or more intermediate DC distribution stages provided with electric batteries.

1. Propulsion system (20, 30; 20′, 30′) for a non-rotary-wing aircraft (1; 2; 3; 4) comprising:
an alternating-current generator (24, 34),
at least one wingtip propulsion unit (22, 32) comprising an alternating-current motor (221, 321), having a direction of rotation that opposes the formation of wingtip vortices,
at least one lift-increase propulsion unit (23a, 23b, 23c, 23d, 33a, 33b, 33c, 33d), comprising an alternating-current motor,
a first AC power supply circuit (25, 35), that electrically connects the generator (24, 34) to the wingtip propulsion unit (22, 32), and
a second AC power supply circuit (26, 36), that electrically connects the generator (24, 34) to the lift-increase propulsion unit (23a, 23b, 23c, 23d, 33a, 33b, 33c, 33d),
the propulsion system (20, 30; 20′, 30′) being characterised in that the second power supply circuit (26, 36) comprises:
an intermediate DC distribution stage (260, 360),
one or more electric batteries (262, 362) connected to said intermediate DC distribution stage (260, 360),
an AC/DC converter (261, 361), that electrically connects the generator (24, 34) to said intermediate DC distribution stage (260, 360), and
a DC/AC converter (263a, 263b, 263c, 263d, 363a, 363b, 363c, 363d), that electrically connects said intermediate stage (260, 360) to the lift-increase propulsion unit (23a, 23b, 23c, 23d, 33a, 33b, 33c, 33d),
and in that the first power supply circuit (25, 35) is configured to deliver (22, 32) an AC current produced by the generator (24, 34), to the wingtip propulsion unit, without intermediate conversion of this alternating current into direct current.

2. Propulsion system (20, 30; 20′, 30′) according to the preceding claim, further comprising a turboprop (21, 31).

3. Propulsion system (20, 30; 20′, 30′) according to any preceding claim,
wherein the first power supply circuit (25, 35) and the second power supply circuit (26, 36) are connected to one another by an AC distribution stage (27, 37), common to these two power supply circuits, the AC distribution stage (27, 37) itself being connected to the generator (24, 34), the AC/DC converter (261, 361) of the second power supply circuit (26, 36) being connected between the AC distribution stage (27, 37) and the intermediate DC distribution stage (260, 360),
and wherein the AC/DC converter (261, 361) is reversible, said converter (261, 361) allowing both a transfer of electric power from the AC distribution stage (27, 37) to the intermediate DC distribution stage (260, 360), and from the intermediate DC distribution stage (260, 360) to the AC distribution stage (27, 37).

4. Propulsion system (20, 30; 20′, 30′) according to any preceding claim, wherein the DC/AC converter (263a, 263b, 263c, 263d, 363a, 363b, 363c, 363d) of the second power supply circuit (26, 36) is reversible, said converter allowing both a transfer of electric power from the intermediate DC distribution stage (260, 360) to the lift-increase propulsion unit (23a, 23b, 23c, 23d, 33a, 33b, 33c, 33d), and from the lift-increase propulsion unit to the intermediate DC distribution stage (260, 360).

5. Propulsion system (20, 30; 20′, 30′) according to any preceding claim, further comprising an electronic control unit (14) that comprises at least one processor and one memory, the control unit (14) being programmed to, during a flight of the aircraft comprising, inter alia, a take-off phase (FP2), a cruising phase (FP4) and a landing phase (FP7), control the motor of the lift-increase propulsion unit (23a, 23b, 23c, 23d, 33a, 33b, 33c, 33d) in such a way that this propulsion unit:
delivers a mechanical propulsion power in the take-off (FP2) or landing (FP7) phase,
but remains off during most of the cruising phase (FP4).

6. Propulsion system (20, 30; 20′, 30′) according to the preceding claim, wherein the control unit (14) of the propulsion system is further programmed to, during most of the flight of the aircraft, control the motor (221, 321) of the wingtip propulsion unit (22, 32) to deliver a mechanical propulsion power.

7. Propulsion system (20, 30; 20′, 30′) according to any preceding claim, wherein the lift-increase propulsion unit (23a, 23b, 23c, 23d, 33a, 33b, 33c, 33d) comprises a fixed-pitch propeller.

8. Propulsion system (20, 30; 20′, 30′) according to any preceding claim, wherein the wingtip propulsion unit (22, 32) comprises a variable-pitch propeller (220, 320).

9. Non-rotary-wing aircraft (1; 2; 3; 4) comprising:
a fuselage (11), a left wing (12) that extends to the left of the fuselage and a right wing (13) that extends to the right of the fuselage,
a first propulsion system (20; 20′) and a second propulsion system (30; 30′), each in accordance with any of the preceding claims,
the wingtip propulsion units (22, 32) of the first and second propulsion systems being located respectively at the tip of the left wing (12) and at the tip of the right wing (13), or inversely,
the lift-increase propulsion units (23a, 23b, 23c, 23d, 33a, 33b, 33c, 33d) being located between the fuselage (11) of the aircraft and the wingtip propulsion units (22, 32).

10. Aircraft (2; 3; 4) according to the preceding claim, wherein:
the first propulsion system (20; 20′) comprises at least two lift-increase propulsion units (23a, 23b, 23c, 23d), one (23a, 23b) located on the left and the other (23c, 23d) located on the right of the fuselage (11), these two lift-increase propulsion units (23a, 23b, 23c, 23d) being both electrically connected to the intermediate DC distribution stage (260) of the first propulsion system (20; 20′), and wherein
the second propulsion system (30; 30′) comprises at least two lift-increase propulsion units (33a, 33b, 33c, 33d), one (33c, 33d) located on the left and the other (33a, 33b) located on the right of the fuselage (11), these two lift-increase propulsion units (33a, 33b, 33c, 33d) being both electrically connected to the intermediate DC distribution stage (360) of the second propulsion system (30; 30′).

11. Aircraft (3; 4) according to claim 9 or 10, wherein
the first propulsion system (20; 20′) and the second propulsion system (30; 30′) each comprise a turboprop (21, 31),
the turboprop (21) of the first propulsion system (20; 20′), which drives the generator (24) of the first propulsion system, is located on the left of the fuselage (11) while the wingtip propulsion unit (22; 32) of the first propulsion system is located at the tip of the right wing (13) of the aircraft, and wherein
the turboprop (31) of the second propulsion system (30;30′), which drives the generator (34) of the second propulsion system, is located on the right of the fuselage (11), while the wingtip propulsion unit (32; 22) of the second propulsion system is located at the tip of the left wing (12) of the aircraft.

12. Aircraft (4) according to any of claims 9 to 11, wherein each wingtip propulsion unit (22, 32) and each lift-increase propulsion unit (23a, 23b, 23c, 23d, 33a, 33b, 33c, 33d) is electrically connected on the one hand to the generator (24) of the first propulsion system (20′) and on the other hand to the generator (34) of the second propulsion system (30′) in such a way as to be electrically powered indifferently either by one or by the other of these two generators (24, 34).
